(19) United States
(12) Patent Application Publication
(10) Pub. No.: US 2011/0127356 A1
(43) Pub. Date: Jun. 2, 2011

(54) ASSEMBLING STRUCTURE FOR UPPER AND LOWER HOUSINGS OF WATER SPRAY GUN

(76) Inventor: Chi-Rung HSU, Taichung (TW)

(21) Appl. No.: 12/627,200

(22) Filed: Nov. 30, 2009

(51) Int. Cl. B05B 9/01; B05B 15/00

(52) U.S. Cl. 239/526

(57) ABSTRACT

An assembling structure for upper and lower housings of a water spray gun, wherein the water spray gun includes a body having the upper and the lower housing, and the assembling structure of upper and lower housings comprises the body including a bore and first and second locking holes, the upper housing includes a first engaging orifice correspond to the bore, a first bolt is used to screw the bore and the first engaging orifice to lock the upper housing to the body, the lower housing includes a second engaging orifice in response to a second locking hole of the body, a second bolt is used to screw the second engaging orifice and the second locking hole to lock the lower housing to the body, thereby assembling the upper and the lower housings together and fixing the first and the second bolts in the upper and the lower housings.

### BACKGROUND OF THE INVENTION

1. Field of the Invention

The present invention relates to an assembling structure for upper and lower housings of a water spray gun that is capable of assembling the upper and the lower housings to the body easily and securely by using the first and the second bolts, and obtaining aesthetics appearance and prolonging service life of the upper and the lower housings.

2. Description of the Prior

Referring to FIGS. 1 and 2, a conventional water spray gun includes a body 11, a spraying head 12, an upper housing 13, and a lower housing 14, wherein the body includes a rear shank 111 connected to an inlet, and the rear shank 111 includes a chamber 112 to receive a control switch disposed on a front end thereof, a front end of the chamber 112 is in connection with a front shank 113, and the front shank 113 includes a connecting segment 114 with an outlet mounted on a front end thereof to couple with the spraying head 12, the upper and the lower housings 13, 14 are injection molded from plastic material and include arcuate first and second coupling surfaces 131, 141 fixed thereon respectively. In assembly, the upper and the lower housings 13, 14, and the body 11 are placed to a mold of an ultrasonic equipment (not shown), and the upper and the lower housings 13, 14 are located above an upper and a lower sides of the body 11, and then the first and the second coupling surfaces 131, 141 of the upper and the lower housings 13, 14 are melted to couple together by using the ultrasonic equipment so that the upper and the lower housings 13, 14 are covered to the body 11 to be operated by user. However, such a conventional water spray gun still has the following disadvantages:

1. The first and the second coupling surfaces 131, 141 of the upper and the lower housings 13, 14 are formed in an arc shape so that the upper and the lower housings 13, 14 are difficult to be assembled together, thus lowering product yield and increasing production cost.

2. Because the first and the second coupling surfaces 131, 141 of the upper and the lower housings 13, 14 are melted to assemble together by using ultrasonic method, the related components can not be replaced if they are broken. For example, when the upper housing 13 is broken, the whole water spray gun has to be replaced, increasing replacement cost.

3. The first and the second coupling surfaces 131, 141 of the upper and the lower housings 13, 14 are melted to assemble together by using ultrasonic method, therefore the protection strength will be decreased. For example, if the water spray gun falls on the ground, the upper and the lower housings are broken or disengaged from each other easily, damaging easily.

The present invention has arisen to mitigate and/or obviate the afore-described disadvantages.

### SUMMARY OF THE INVENTION

The primary object of the present invention is to provide an assembling structure for upper and lower housings of a water spray gun that is capable of assembling the upper and the lower housings to the body easily and securely by using the first and the second bolts.

A further object of the present invention is to provide an assembling structure for upper and lower housings of a water spray gun that is capable of fixing the first and the second bolts in the upper and the lower housing, obtaining aesthetics appearance and prolonging service life of the upper and the lower housings.

Another object of the present invention is to provide an assembling structure for upper and lower housings of a water spray gun that is capable of rejection molding the flexible grip portion into the body, holding the water gun comfortably.

An assembling structure for upper and lower housings of a water spray gun according to a preferred embodiment of the present invention, the water spray gun includes a body having the upper and the lower housing, and the assembling structure of upper and lower housings comprises:

the body including a bore and first and second locking holes, and the upper housing including a first engaging orifice in response to the bore of the body, a first bolt being used to screw the bore and the first engaging orifice to lock the upper housing to the body, the lower housing including a second engaging orifice in response to a second locking hole of the body, and a second bolt being used to screw the second engaging orifice and the second locking hole to lock the lower housing to the body, thereby assembling the upper and the lower housings together and fixing the first and the second bolts in the upper and the lower housings.

### BRIEF DESCRIPTION OF THE DRAWINGS

FIG. 1 is a perspective view showing the exploded components of a conventional assembling structure for upper and lower housings of a water spray gun;

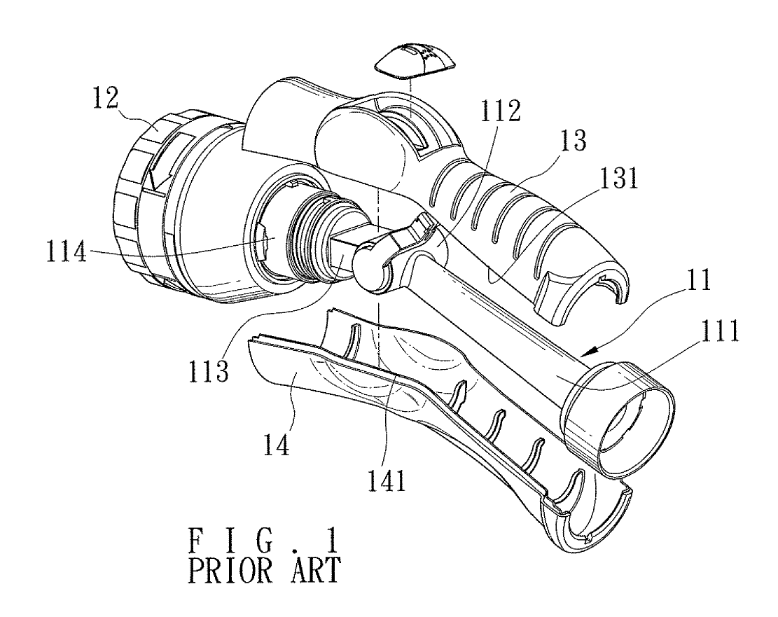

FIG. 2 is a perspective view showing the assembly of the conventional assembling structure for the upper and lower housings of the water spray gun;

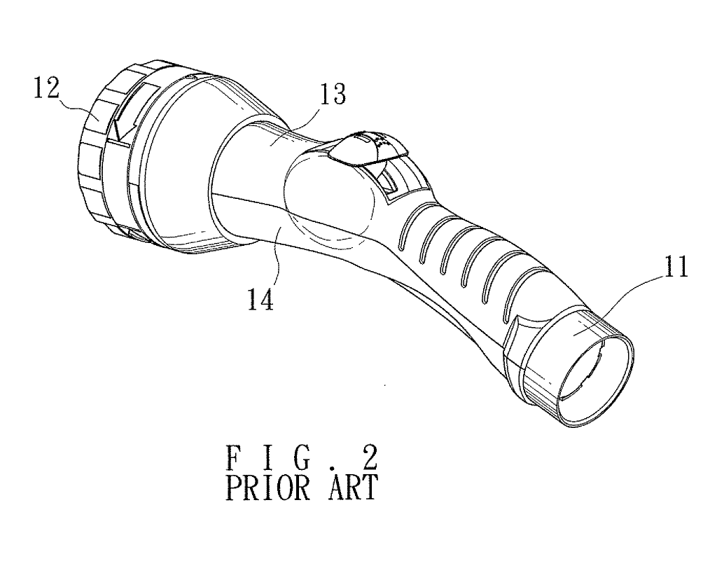

FIG. 3 is a perspective view showing the exploded components of a water spray gun according to a preferred embodiment of the present invention;

FIG. 4 is a cross sectional view showing the assembly of a body of the water spray gun according to the preferred embodiment of the present invention;

FIG. 5 is a cross sectional view showing the assembling operation of the water spray gun according to the preferred embodiment of the present invention;

FIG. 6 is another cross sectional view showing the assembling operation of the water spray gun according to the preferred embodiment of the present invention;

FIG. 7 is also another cross sectional view showing the assembling operation of the water spray gun according to the preferred embodiment of the present invention;

FIG. 8 is a perspective view showing the assembly of the water spray gun according to the preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

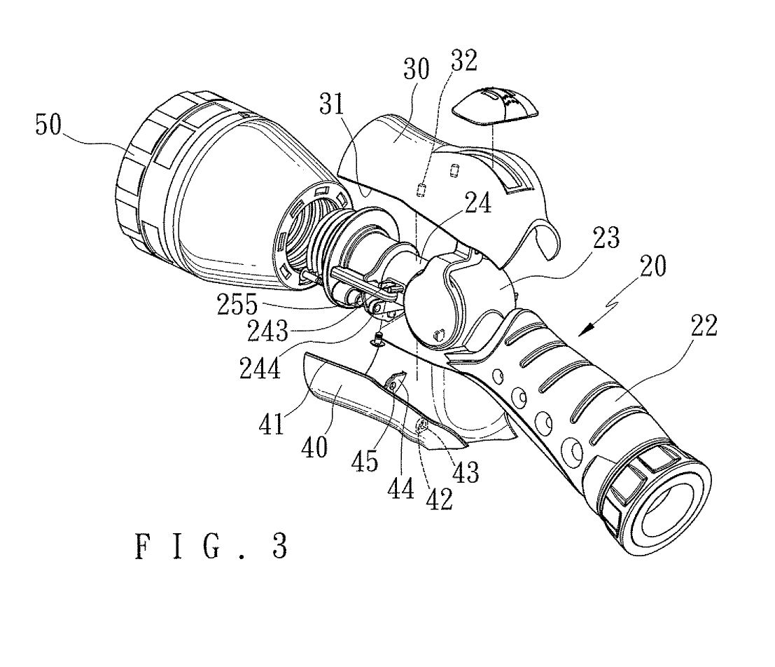

Referring to FIGS. 3-5, a water spray gun comprises a body 20, an upper housing 30, a lower housing 40, and a spraying head 50, wherein the body 20 includes a rear shank 21 injection molded thereon, and includes a flexible grip portion 22 having a peripheral projection 221 mounted on a front end of the grip portion 22 to be held by a user, and a front end of the rear shank 21 is coupled to a chamber 23 to be provided with a control switch, the chamber 23 includes a front shank 24 fixed on a front side thereof and having a plate member 241 secured on a front side of the front shank 24, the front shank 24 including a connection portion with outer threads formed on an end portion thereof or on a connector 25. In this embodiment of the present invention, the connector 25 includes a connection portion with outer threads formed on the end portion thereof, and includes an insertion 253 disposed on a rear side thereof to be inserted to a plate member 241 of the front shank 24 so that the body 20 allows to be provided with the spraying head 50 by using a connecting segment 252. The upper housing 30 is injection molded from plastic or metal material. In this embodiment of the present invention, the upper housing 30 is injection molded from metal material, and includes an arcuate first coupling surface 31 arranged on a bottom surface thereof, and the lower housing 40 is injection molded from plastic or metal material. In this embodiment of the present invention, the lower housing 40 is injection molded from metal material, and includes an arcuate second coupling surface 41 in response to the first coupling surface 31 of the upper housing 30, wherein an assembling structure of the upper and the lower housings 30, 40 includes at least one first tab 242 with a bore 243 mounted on the front shank 24 of the body 20, and the bore 243 is formed in a longitudinal arrangement, the connector 25 includes a through aperture 254 fixed on the insertion 253 in response to the bore 243, and the body 20 includes at least one locking hole. In this embodiment of the present invention, the plate member 241 and the connector 25 includes a first locking hole 244 and a second hole 255 respectively disposed thereon to correspond to each other, and the chamber 23 of the body 20 includes a guiding peg 231 laterally fixed on a bottom surface thereof, the upper housing 30 includes a first positioning member 32 with a first engaging orifice 33 secured on an inner wall thereof to correspond to the bore 243 of the body 20, and the lower housing 40 includes a second tab 42 with an opening 43 arranged on an inner wall thereof to correspond to the guiding peg 231 of the body 20, and includes a second positioning member 44 with a second engaging orifice 45 disposed thereon in response to the first locking hole 244 of the body 20.

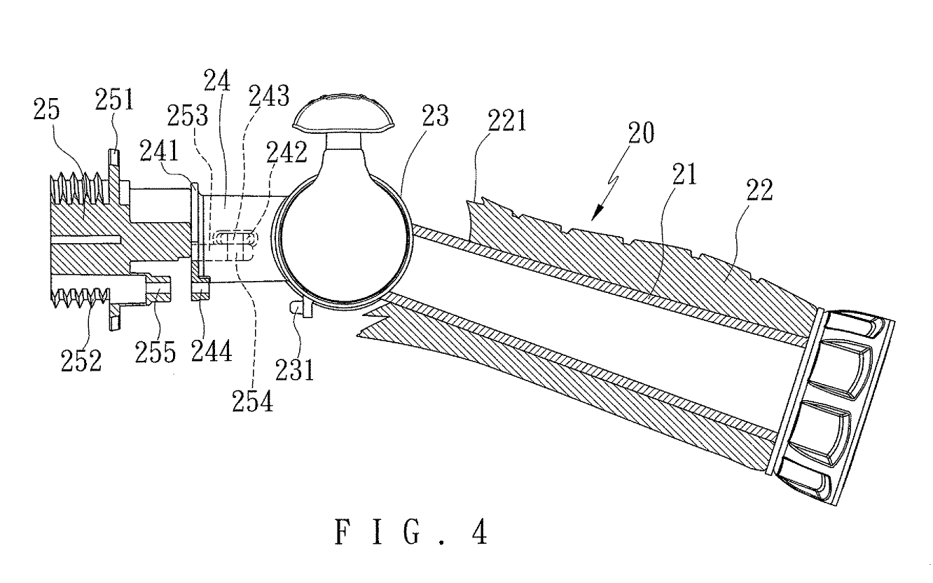

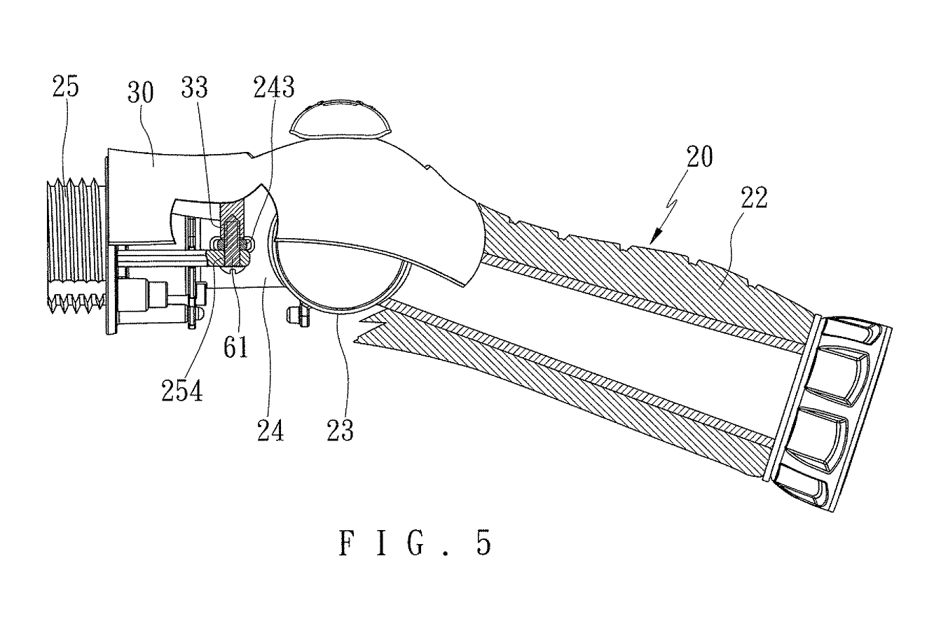

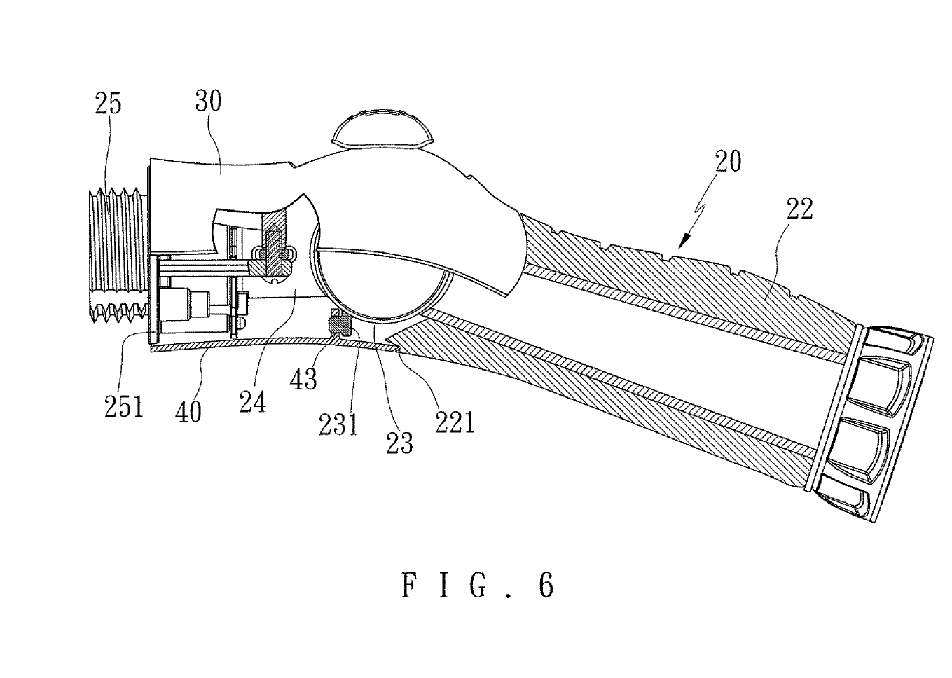

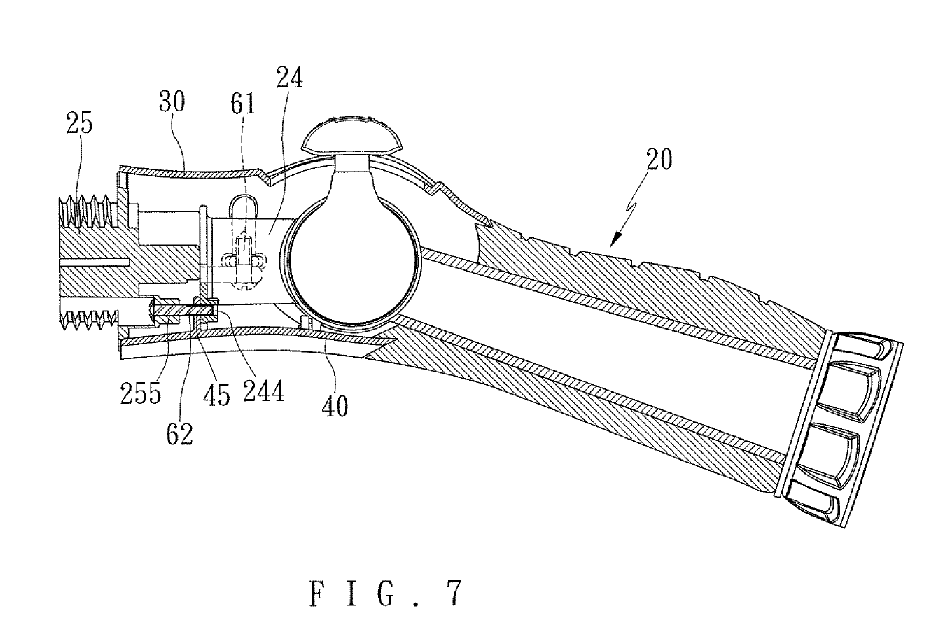

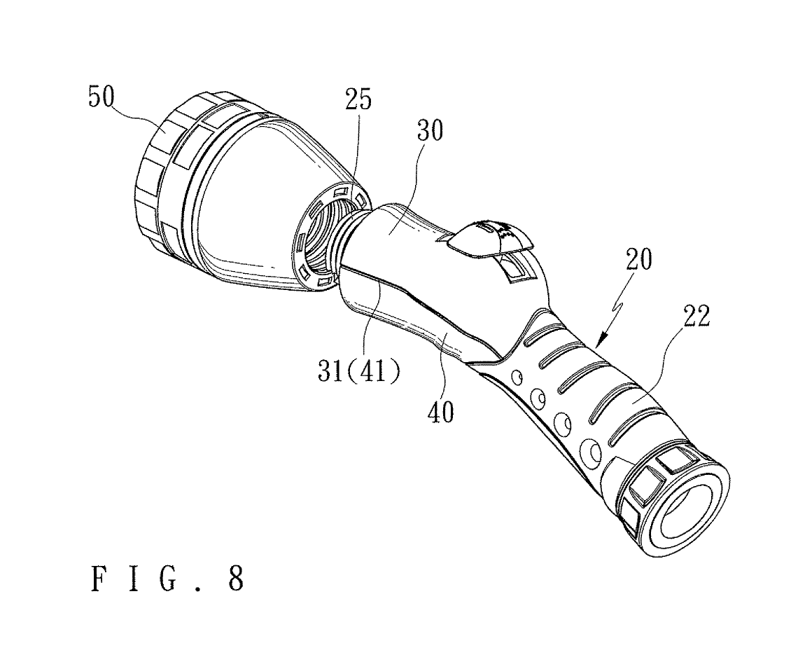

Referring to FIGS. 4 and 5, in assembly of the upper housing 30, front and rear ends of the upper housing 30 are placed to the peripheral projection 221 of the grip portion 22 of the body 20 and the plate member 251 of the connector individually to be located above the chamber 23 and the front shank 24 of the body 20, and the first engaging orifice 33 is aligned to the bore 243 of the body 20. Thereafter, a first bolt 61 is inserted to the through aperture 254 of the connector 25 and the bore 243 of the front shank 24 to be screwed to the first engaging orifice 33 of the upper housing 30, thus assembling the upper housing to the body 20, wherein the first bolt 61 is fixed into the upper housing 30 to obtain aesthetics appearance. As shown in FIGS. 4 and 6, front and rear ends of the lower housing 40 are placed to the peripheral projection 221 of the grip portion 22 and the plane 251 of the connector 25 respectively to be located below the chamber 23 of the body 20 and the front shank 24 and to be fitted to the guiding peg 231 of the body 20 by using the opening 43, thereby positioning the lower housing 40. As illustrated in FIGS. 7 and 8, the second engaging orifice 45 of the lower housing 40 is aligned with the first locking hole 244 of the body 20, and then a second bolt 62 is inserted to the second locking hole 255 of the connector 25 and the second engaging orifice 45 of the lower housing 40 to be screwed to the first locking hole 244 of the front shank 24, thereby locking the lower housing 40 to the body 20, and the second coupling surface 41 of the lower housing 40 engages with the first coupling surface 31 of the upper housing 30 to assemble the upper and the lower housings 30, 40 together. Furthermore, the second bolt 62 is fixed to the connector 25 of the body 20, therefore as the spraying head 50 is installed to a front side of the connector 25, the second bolt 62 is covered by the lower housing 40, thus obtaining aesthetics appearance. Accordingly, the upper and the lower housings 30 and 40 are fixed in the body 20 to protect the first and the second bolts 61, 62, prolonging the service life and enhancing aesthetics appearance.

While we have shown and described various embodiments in accordance with the present invention, it is clear to those skilled in the art that further embodiments may be made without departing from the scope of the present invention.

What is claimed is:

1. An assembling structure for upper and lower housings of a water spray gun, the water spray gun including a body having the upper and the lower housing, and the assembling structure of upper and lower housings comprising:
the body including a bore and first and second locking holes, and the upper housing including a first engaging orifice in response to the bore of the body, a first bolt being used to screw the bore and the first engaging orifice to lock the upper housing to the body, the lower housing including a second engaging orifice in response to a second locking hole of the body, and a second bolt being used to screw the second engaging orifice and the second locking hole to lock the lower housing to the body, thereby assembling the upper and the lower housings together and fixing the first and the second bolts in the upper and the lower housings.

2. The assembling structure for upper and lower housings of the water spray gun as claimed in claim 1, wherein the body includes a front and a rear shanks between which is defined a chamber.

3. The assembling structure for upper and lower housings of the water spray gun as claimed in claim 2, wherein the body includes a first tab with a bore mounted on the front shank thereof, and the front shank includes a plate member having a first locking hole disposed thereon, the upper housing includes a first positioning member with the first engaging orifice secured on an inner wall thereof to correspond to the bore of the body, and the lower housing includes a second positioning member with the second engaging orifice disposed thereon in response to the first locking hole of the body.

4. The assembling structure for upper and lower housings of the water spray gun as claimed in claim 2, wherein and the chamber of the body includes a guiding peg laterally fixed on a bottom surface thereof, and the lower housing includes a second tab with an opening arranged on an inner wall thereof to correspond to the guiding peg of the body.

5. The assembling structure for upper and lower housings of the water spray gun as claimed in claim 2, wherein the rear shank of the body includes a flexible grip portion.

6. The assembling structure for upper and lower housings of the water spray gun as claimed in claim 5, wherein the rear shank of the body includes the grip portion injection molded thereto, and the grip portion has a peripheral projection mounted on a front end thereof.

7. The assembling structure for upper and lower housings of the water spray gun as claimed in claim 2, wherein the body allows to be provided with the spraying head by using a connecting segment.

8. The assembling structure for upper and lower housings of the water spray gun as claimed in claim 7, wherein the front shank includes a connection portion with outer threads formed on an end portion thereof.

9. The assembling structure for upper and lower housings of the water spray gun as claimed in claim 7, wherein the front shank includes a connection portion with outer threads formed on a connector, and the connector includes a connection portion with outer threads formed on the end portion thereof.

10. The assembling structure for upper and lower housings of the water spray gun as claimed in claim 7, wherein the connector includes a plane having a connecting segment formed on a front side of the plane, and includes an inserted to the front shank of the body, includes a through aperture fixed thereon in response to the bore of the body, and includes a second hole to correspond to the first locking hole of the front shank.

11. The assembling structure for upper and lower housings of the water spray gun as claimed in claim 1, wherein the upper housing includes an arcuate first coupling surface arranged on a bottom surface thereof, and the lower housing includes an arcuate second coupling surface in response to the first coupling surface of the upper housing.
